(19) United States
(12) Patent Application Publication
(10) Pub. No.: US 2007/0131624 A1
(43) Pub. Date: Jun. 14, 2007

(54) Submersible reservoir management system

(76) Inventors: Amir Ali Giti, Redondo Beach, CA (US); Earl Ahrens, Rancho Palos Verdes, CA (US)

Correspondence Address: D'AMBROSIO & ASSOCIATES, P.L.L.C., 10260 WESTHEIMER, SUITE 465, HOUSTON, TX, 77042, US

(21) Appl. No.: 11/637,994

(22) Filed: Dec. 13, 2006

Related U.S. Application Data
(63) Continuation-in-part of application No. PCT/US04/18802, filed on Jun. 14, 2004.

(51) Int. Cl. C02F 1/00

(52) U.S. Cl. 210/739; 210/749; 210/220

(57) ABSTRACT

A submersible reservoir management system for large water reservoirs comprising a submersible pump assembly including a frame that is removably attached to the pump assembly. The frame stabilizes the pump assembly when it is submerged and floating and supports the pump assembly when it is resting on the bottom of the reservoir. The frame can comprise a base and struts or, alternatively, a tripod. One or more ballast tanks can be mounted onto the frame with the submersible pump is positioned between the ballast tanks. Water is used as ballast to submerge the system so that it rests on the bottom of the reservoir. The submersible pump assembly adds disinfecting chemical when necessary to control water quality and produces a jet stream to provide circulation of the chemicals and temperature uniformity within the reservoir.

### CROSS REFERENCE TO RELATED APPLICATIONS

This application is a continuation-in-part of PCT/published application, WO 2006/001800 A1, International Application No. PCT/US2004/018802 filed on 14 Jun. 2004.

### FIELD OF THE INVENTION

The present invention relates to a submersible reservoir management system, more particularly, to a system for positioning a reservoir management system that controls water impurity level and maintains temperature uniformity within a large water reservoir.

### BACKGROUND OF THE INVENTION

Large water-containing reservoirs require management of temperature gradients and microbe development to ensure high quality water for dispensing to municipalities and the like. Because of their size, these reservoirs have a problem with water at or near its surface that can become warmer during the summer, particularly in temperate zones. Make-up water usually is colder and, while it may reduce the temperature, is not very effective and instead make-up water can short-circuit the retained water in the reservoir. Temperature gradients accompanied by ineffective mixing of disinfectant chemicals result. Because the bodies of water are so large both in width and depth, even with a reservoir management system in place, regulation of temperature and the addition of chemicals is often uneven. Stagnation and stratification can occur because of the limited area, below and above the surface, that is circulated by existing reservoir management systems. Circulation of make-up water and added chemicals throughout the reservoir is spotty and limited resulting in inconsistent water quality.

Various methods and devices are known for positioning equipment both on the surface and underneath water in reservoirs. U.S. Pat. No. 4,642,919 teaches an apparatus for removing sludge from a settling basin. The apparatus comprises pontoons and a submersible pump having a suction inlet and a discharge outlet. The pontoons comprise a pair of laterally spaced, longitudinal pontoons having a plurality of compartments into each of which selective amounts of air and water are introduced. The pump is vertically pivotal on the pontoons so as to move the suction inlet to selective depths in the sludge basin to variably dilute the sludge. Selective amounts of air and water are introduced into the pontoons to serve as a variable ballast to submerge and maintain the pontoons at selective distances above the bottom of the basin. U.S. Pat. No. 5,021,154 discloses an apparatus for mixing or aerating waste water. The device comprises a reversible motor, a downward oriented shaft driving a propeller, a guide tube and at least two flotation elements. The lower end of one of the flotation elements includes a ballast chamber inside the float.

U.S. Pat. No. 6,273,402 teaches a submersible in-situ oxygenator comprising a mixer for gas and liquids while concomitantly mixing and suspending solids and sludge at the bottom of a deep tank. In another aspect of the present invention, an adjustable jet aerator may be installed on a submersible hollow float, or ballast chamber, with the jet pointing downwards to entrain oxygen. Different from fixed position jet aerators, the adjustable jet aerator provides the flexibility of changing mixing intensity at the tank bottom due to changing solid loading and process conditions.

U.S. Pat. No. 5,510,022 discloses a pond aerator comprising a pump, a spraying mechanism, a power source, floating mechanism adapted for keeping the inlet of the pump submerged, and an anchor. U.S. Pat. No. 4,089,620 discloses a floating pumping device comprising a float, an upright draft tube, a propeller, and a submersible pump. A combined mixer aerator is disclosed in U.S. Pat. No. 6,276,670 that comprises a power driven shaft and propeller. The device further comprises a support plate which is connected to floats. The Background of the Invention also discloses European patent 0.366.644 which describes an aerator which can be used as a mixer. The device including two floats, one on top of the other. The lower float can be immersed by the introduction of ballast but it appears to have limited submersible capacity since the top float is never submerged. This patent uses a propelling device to raise and lower the aerator.

U.S. Patent Application 20030143082 discloses a floating pump assembly which can be arranged so that the pump housing can be submerged or partially submerged while the pump floats above the water line. The predetermined orientation of the pump housing and fluid drive assembly and resulting path of water flow maintain the pump housing it its submersible location.

Floating pumps and pumps that are partially submersible do not resolve the problem of stratification of temperature and uneven distribution of chemicals throughout the reservoir. Existing submersible reservoir management systems have an additional problem of maintaining stability at greater depths. Special problems occur in earthquake prone areas. Certain districts, California for example, have government requirements which provide for stringent seismic requirements that affect the use of submersibles. Consequently, it appears that there is a need for a system that provides for uniform disinfection and maintains uniformity in temperature by effective re-circulation of stratified waters within the reservoir.

### SUMMARY

The submersible reservoir management system for large water reservoirs of the present application comprises a submersible pump assembly comprising a submersible pump and a frame that is removably attached to the pump. The frame supports and stabilizes the pump when it is submerged, even when resting on the bottom of the reservoir. In one embodiment of this invention, one or more ballast tanks are mounted onto the frame. Water is used as the ballast. As air is exhausted from the ballast tanks and replaced by water, the pump submerges within the reservoir. The ballast tanks can comprises one or more air hoses, one or more water inlets and one or more water outlets. The frame can comprise a tripod, the tripod having a bracing means to support the submersible reservoir management system. Alternatively, the frame can comprise a base, the base of the frame providing a more stable support, if needed, as the reservoir management system rests on the bottom of the reservoir. The frame allows the submersible pump to move both horizontally throughout the reservoir so that the pump, which is a recirculating pump can provide improved mixing of chemicals and reduce temperature gradients within the reservoir. The addition of the ballast tanks allows for vertically positioning of the submersible pump further improving circulation of chemicals and heat throughout the reservoir. The improved circulation avoids temperature stratification and stagnation that is problematic in prior large reservoir.

In one aspect of the submersible reservoir management system, the submersible pump assembly comprises one or more submersible pumps and one or more jet mixers for mixing and circulating water. The assembly is connected to a means for analyzing reservoir water for chemical content and means for adding chemicals. One preferred system comprises a frame. The frame can comprise a base that is rectangular, and four struts, each strut having a base end and a mounting plate end, each base end connected to a corner of the base and each mounting plate end securely attached to the mounting plate. The mounting plate further comprises one or more flanges and the four struts are attached to the one or more flanges of the mounting plate. In an alternative embodiment the frame comprises a tripod. The tripod has its legs angled to attached to the pump and provides a lighter weight frame system for supporting the submersible pump assembly on the floor of the reservoir. Preferably, a bracing means is also used to attach and brace the legs of the tripod to the pump system.

Preferably, the mounting plate and its one or more flanges are smaller than the base so that the struts angle inward from the base to the mounting plate and the reservoir management system is positioned between the ballast tanks to stabilize the system. One or more bands are used to secure the submersible pump to the mounting plate. Preferably, the bands comprise u-bolts. One or more trusses are used to secure the one or more ballast tanks to the mounting plate.

In one preferred embodiment, the submersible pump comprises means to produce a jet of water therefrom within the water reservoir and means to ingest water from the reservoir at a point remote from the jet. The jet mixer can be positioned in the jet of water to draw low pressure water surrounding the jet mixer and to discharge a stream of water therefrom to mix and circulate the water within the reservoir and to remove temperature gradients in the body of water. The submersible pump can further comprise means for adding at least one of ammonia, hypochlorite, and chlorine to the body of water, the means designed to add one of the ammonia, hypochlorite, and chlorine to the stream of water discharging from the pump or the jet mixer, means for removing a test stream of water from the reservoir on a continuous basis, the means designed to remove the test stream remote from the water discharging from jet mixer. In this embodiment the system is connected to an analyzer for determining the level of at least one of chlorine and chloramine in the test stream to provide a chlorine or chloramine related signal. A controller is designed to receive the signal and to compare the signal to a set point indicative of the level of chlorine or chloramine desired in the reservoir water to provide a comparison. In response to the comparison, the controller maintains, increases, or decreases the amount of ammonia, hypochlorite, or chlorine added to the body of water in the reservoir.

In one preferred method for submerging a reservoir management system for water reservoirs to circulate the water, monitor and add chemicals to the water and reduce temperature gradients, the method comprises locating a submersible pump in the reservoir. This preferred method comprises a reservoir management system having a submersible pump assembly that is securely mounted to a frame in a position for optimum stabilization. In one embodiment of this method, the frame preferably has a base, a support mounting plate and one or more struts connecting the base to the support mounting plate. In this embodiment, the frame further comprises an inner control area and the reservoir management system is positioned within this control area. Preferably, a submersible pump is attached onto the support mounting plate within the inner central area for improved stabilization. One or more flanges are attached perpendicular to the mounting plate and the submersible pump is positioned between the arms of the flanges. Alternatively, the frame comprises a tripod. The legs of the tripod provide stability as the submersible pump floats and support the submersible pump when the reservoir management system is at rest on the floor of the reservoir.

In one advantageous embodiment of this invention, one or more ballast tanks are attached to the submersible pump assembly. The pump can be operated in one location and then repositioned vertically within the reservoir by increasing or decreasing the ballast within the one or more ballast tanks to provide mixing action within the reservoir so as to diminish temperature gradients within water contained in the reservoir and to efficiently mix chemicals added thereto for treatment purposes. Repositioning the reservoir management system horizontally within the reservoir is accomplished manually or by motorized vehicles.

### BRIEF DESCRIPTION OF THE DRAWINGS

FIG. 1 is a three dimensional view of one embodiment of the submersible reservoir management system of this invention.

FIG. 2 is a cross-sectional view of the submersible pump.

FIG. 3 is a schematic of another embodiment of a reservoir management system.

FIG. 4 is a three dimensional view of still another embodiment of the reservoir management system.

### DETAILED DESCRIPTION

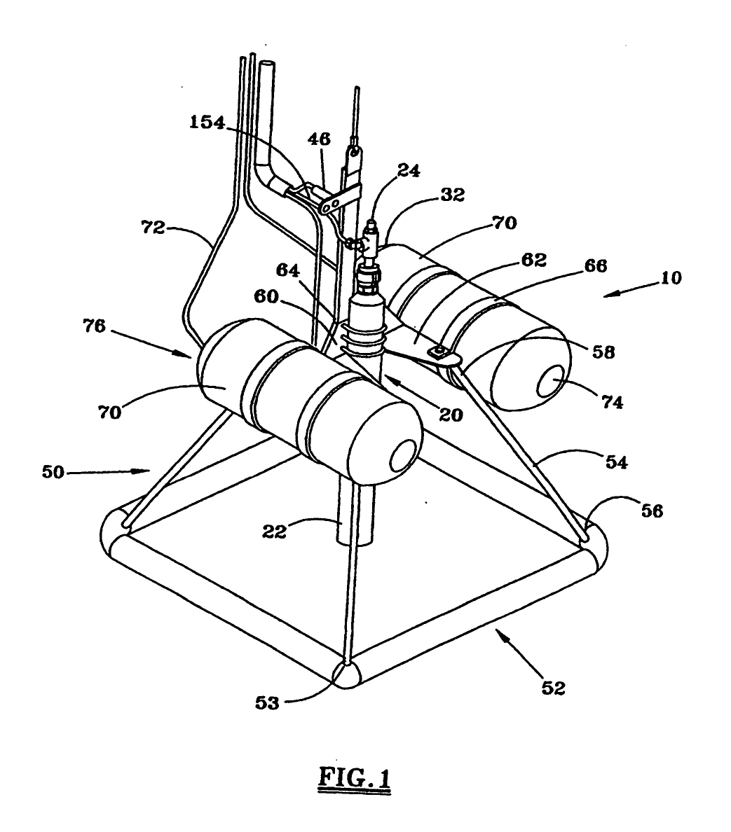

As illustrated in FIG. 1, the submersible reservoir management system 10 for water reservoirs of the present application comprises a submersible pump assembly 20 having a frame 50, 80 that provides stability both as the pump assembly 20 is floating through the water and when it rests on the bottom of the reservoir 100. Reservoir management systems 10 are used to control the chemical disinfectant content within the reservoir to avoid stagnation and to circulate the water to reduce temperature stratification. One such reservoir management system 10 is disclosed in International Publication, no. WO 2006/001800 filed Jun. 14, 2004, which is fully incorporated herein by reference. Advantageously, the reservoir management system 10 of the present invention comprises one or more pumps 22 encased within a frame 50, 80 that is submergible within the reservoir 100 until a base 52, of the frame 50 rests or is moved along the bottom 110. In one embodiment, the frame 80 is a tripod and the legs 82 of the tripod support the pump 22 when resting or moving on the bottom 110 of the reservoir. The one or more pumps 22 can be operated in one location and then repositioned horizontally within the reservoir by moving the frame, 50, 80 manually or with motorized vehicles. Vertical movement occurs with the use of one or more ballast tanks 70. Increasing or decreasing the ballast within one or more ballast tanks will cause the lowering or raising of the submersible pump assembly within the reservoir 10. Repositioning the pump 22 results in improved circulation so as to diminish temperature gradients within water contained in the reservoir 100 and more efficient mixing of chemicals added thereto for treatment purposes. The frame 50, 80 supports and stabilizes the pump 22 as it is submerging, moving throughout the reservoir 100 or resting on the bottom of the reservoir 100. Preferably, the pump 22 is positioned within the frame 50 for optimum stability. It maintains a vertical alignment as it is being moved within the reservoir or during seismic upsets such as earthquakes that are problematic in certain geographic areas.

In one preferred embodiment, the one or more submersible ballast tanks 70 are mounted onto the submersible pump assembly on either side of the pump with the submersible pump 22 positioned in the middle. Water is used as the ballast. As air is exhausted from the ballast tanks 70 and replaced by water, the submersible pump 22 submerges within the reservoir 100. The ballast tanks 70 comprise one or more air hoses 72 attached to an air pump (not shown) for pumping air into the tanks 70 to raise up the assembly 20 and one or more water inlets 74 and one or more water outlets 76 used when ballast is required to lower the system. The ballast tanks 70 can be comprised of high density linear polyethylene. All parts of the frame are preferably comprised of stainless steel for durability and weight.

As shown in FIG. 1, the submersible reservoir management system 10 comprises a submersible pump assembly having a submersible pump 22 and an jet mixer 24 in communication with the pump for mixing and circulating water. In alternate embodiments, the pump assembly 20 can comprise one or more submersible pumps 22 and one or more jet mixers 24. For simplicity, one pump and one jet mixer will be used to describe the embodiment in this detailed description of the invention. The submersible pump 22 is attached to a means for analyzing reservoir water for chemical content shown as an analyzer, 26 and means for adding chemicals, such as lines, 46, 154, when necessary. In one embodiment of this invention, the frame 50 supports the submersible pump 22 and the ballast tanks 70, all of which are securely attached to the frame 50 to prevent slippage. The frame 50 comprises a base 52 that is preferably rectangular to provide stability, support struts 54 and a mounting plate 60 to which the struts 54, submersible pump 22 and ballast tanks 70 are attached. The base 52, made from stainless steel, is approximately 2 inches in width and heavy enough to weigh down the submersible pump assembly 20 within the reservoir 100 so that it does not sway or move about undesirably. Four struts 54 are illustrated, each strut 54 having a base end 56 and a mounting plate end 58. Each base end 56 is connected to a corner 53 of the base and each mounting plate end 58 is securely attached to the mounting plate 60. The mounting plate 60 further comprises one or more flanges 62 perpendicular to the plate 60 and the four struts 54 are attached to the one or more flanges 62.

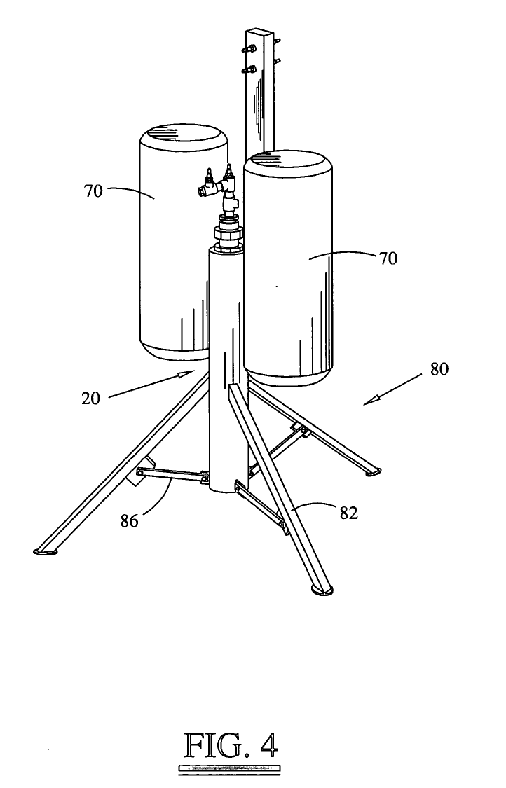

The heavy base 52 forms the bottom of the frame 50 for stabilizing the reservoir management system and supporting the reservoir management system when the base 52 is positioned on the bottom of the reservoir 100. As illustrated in FIG. 1, the width of the mounting plate 60 is considerably smaller than the base 52 so that the struts 54 angle inward from the base 52 to the mounting plate 60. This configuration, along with the weight of the base, provides stability to the submerged reservoir management system 10. The one or more submersible pumps 22 and one or more jet mixers 24, are securely attached to the mounting plate 60 between the ballast tanks 70 to further stabilize the system. One or more bands 64 are used to secure the submersible pump 22 to the mounting plate 60. Preferably, the bands 64 comprise u-bolts. One or more trusses 66 are used to secure the one or more ballast tanks 70 to the mounting plate 60. In one preferred embodiment, wheels can be placed on the base to facilitate movement on land, prior to placing the submersible reservoir management system 10 into the reservoir 100. FIG. 4 illustrates another embodiment of this invention in which the frame 80 is a tripod 80. The legs 82 of the tripod each have one end that is securely and rotably attached to the pump 22. The other end of each leg is adapted to lie on the floor of the reservoir 100. The tripod frame 80 can further comprise bracing means which also are rotably attached to the pump 22 to brace and further support the pump 22 within the frame 80.

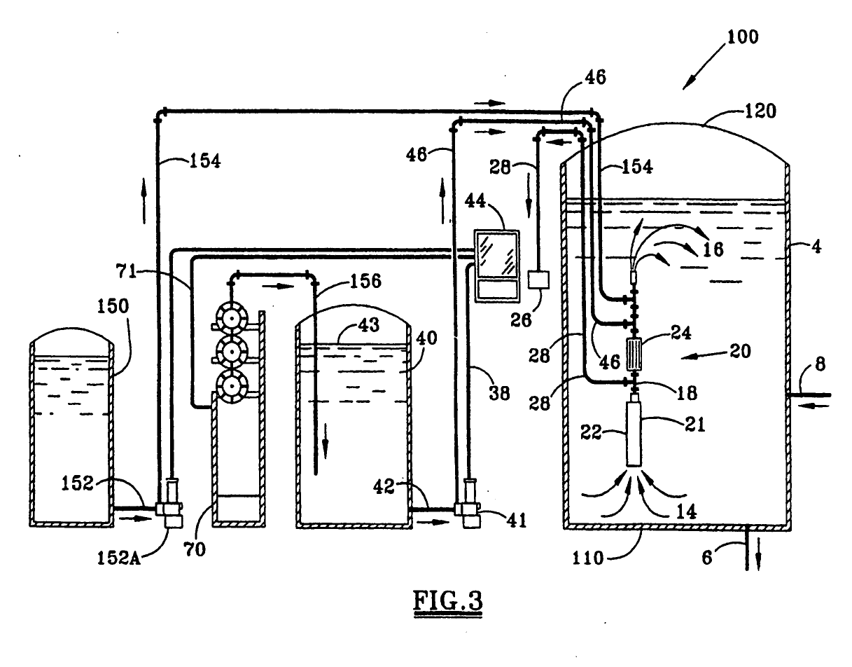

FIG. 3 is a schematic illustrating a method and system for submerging a reservoir management system to maintain a reservoir substantially free of temperature gradients and also to maintain the body of water under high quality conditions suitable for the end users. Water is dispensed from reservoir 100 along line 6 and added to reservoir 100 along line 8. Preferably, water is dispensed from bottom of the reservoir to utilize pressure from head of water in reservoir 100. As noted previously, large reservoirs have the problem that water in the reservoirs becomes warm, particularly in hot climates. Make-up water introduced to the reservoir usually is colder and, without recirculation, leaves warmed areas that can result in the retained water becoming stagnant and generally unsuitable for use. Submerging the reservoir management system to the depths of the reservoir increases the circulation of water for a more homogenous mixing of chemicals and water temperature. The submersible pump 22 stirs or mixes the water contained in the reservoir 100. In operation, the submersible pump 22 ingests water at lower portion or bottom 21 from adjacent the reservoir bottom 110 as illustrated by water flow arrows 14 and discharges a jet 18 of water by means of nozzles 32.

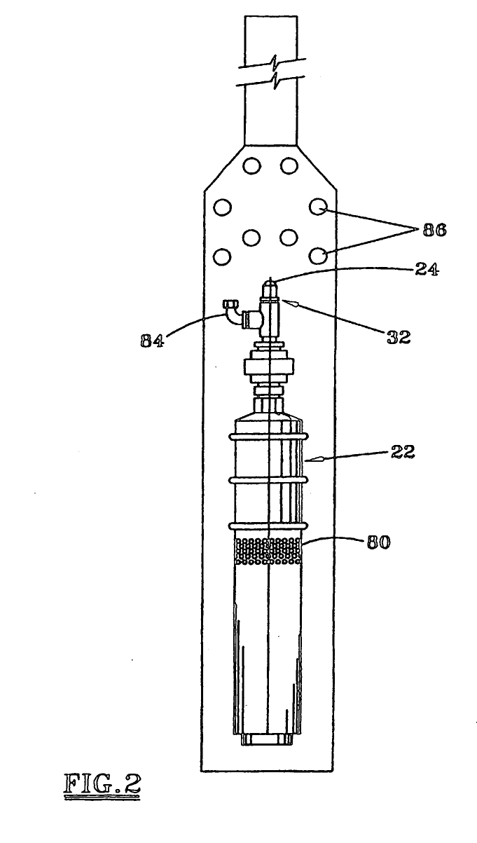

An important aspect of the subject invention is a submersible pump 22 used in combination with jet mixer 24 (also known as an eductor) as illustrated in FIGS. 1, 2 and the schematic of FIG. 3. This combination has the effect of providing more efficient mixing in large reservoirs. That is, the use of jet mixer 24 improves mixing by moving or utilizing 3 to 5 more volumes of water in the reservoir. Thus, this has the advantage of providing for superior mixing of disinfectants or chemicals and in addition provides for more uniformity of temperature within reservoir 100 and avoidance of stagnation. The jet mixer 24 provides additional mixing by using a jet 18 of water that is discharged from the pump nozzle 32 which is at a higher pressure than water surrounding the nozzle 32. That is, the jet of water 18 from the submersible pump 22 acts as the pumping fluid in the jet mixer 24. As the jet of water passes through a venturi in the jet mixer 24, it develops a suction which causes some of the surrounding water to be taken into the jet mixer 24 and entrained with jet 18, causing further or additional mixing in the reservoir in the stream 16 emerging from the mixer 24. For example, if the rate of water emerging from the pump nozzle 32 is 5 gal./min., the action of the jet mixer 24 increases the rate of water emerging from it to 125 gal./min.

Referring to FIGS. 1 and 2, the one or more submersible pumps 22 have a perforated water intake 80 and an injection nozzle exit 32. Water sample line 28 (FIG. 3) may be connected to coupling 84 for purposes of continuously removing a water sample which is forwarded or directed to chemical analyzer 26. The water jet emanating from nozzle exit 32 is used to power the jet mixer 24. Holes or apertures 86 in the mounting plate 60 for the pump 22 are used to accommodate chemical dosing lines 154 and 46 which can be located below or above the jet mixer 24. For most applications, a 1 HP stainless steel submersible pump is suitable. A jet mixer useful with a 1 HP pump can provide about five times the flow or about 50 gpm. Typically the pump assembly 20 is mounted in a generally vertical direction approximately within about 10 feet above the bottom of the tank.

The submersible reservoir management system 10 of this invention can be easily retrofitted within a reservoir 100 since no permanent attachments are required. Reservoirs 100 are typically fitted with a top 120, in some cases, a floating top. Prior reservoir management systems suspended the submersible pump 22 and jet mixer 24 by a strut attached to the pump 22. Rippling seismic waves or earthquakes, sometimes having in excess of 30,000 lbs. of force, can severely damage both the reservoir top 120 and submersible pump 22. The submergible reservoir management system of this invention is free from the reservoir itself and stabilized by the frame 50, 80 and, when attached to the submersible pump assembly, the ballasts 70. It reduces the requirement of seismic restraints for the submersible pump assembly 20.

In another aspect of the invention, the chemistry of the water in reservoir 100 is maintained by continuous sampling of the water and adjusting the amount of chemicals such as ammonia and chlorine-containing materials such as chlorine gas, chlorite, chlorine dioxide and hypochlorite added thereto. That is, in accordance with the invention, a small stream of water is removed from the reservoir 100 on a continuous basis along line 28 to a water analyzer 26 where the amount of free chlorine and total chlorine are measured. These measurements may be used to generate chlorine or chloramine-related measurement signals which are electrically communicated along line 32 to a controller 44 such as programmable logic controller (PLC). The programmable logic controller 44 is set up to compare the chlorine or chloramine-related measurement signals with a set point, and the programmable logic controller 44 then determines whether the amount of chlorine in the water should be maintained, or should be adjusted upwardly or downwardly.

In the present invention, the amount of chlorine and chloramine in the water is preferably controlled by addition of chlorine or chlorine-containing compound such as hypochlorite and ammonia added. Typically, free chlorine and chloramines are maintained in the range of 0.01 to 10 ppm in the reservoir. Referring to FIG. 3, hypochlorite such as sodium hypochlorite is added from a source or supply 40. Sodium hypochlorite solution is added along line 42 to pump 41 and is directed along line 46 to the reservoir 100. Preferably, the sodium hypochlorite is added above the jet mixer 24 for purposes of more efficient mixing with the water from jet mixer 24 and distribution throughout the water.

If the determination is made by programmable logic controller 44 that the level of chloramines are high compared to chlorine in the water, this indicates that sodium hypochlorite is required to be added. Thus, the programmable logic controller 44 sends a signal along line 38 to pump 41 to increase the amount of sodium hypochlorite solution being added to the reservoir. It will be appreciated that programmable logic controller 44 can be programmed to calculate the amount of sodium hypochlorite to be introduced to the reservoir for correction purposes. Further, if sodium hypochlorite is already being added, programmable logic controller 44 can be programmed to calculate the additional amount of sodium hypochlorite to be introduced to the water in the reservoir.

If the determination is made by analyzer 26 and programmable logic controller 44 that the level of chlorine is high compared to chloramines, this indicates that ammonia is low in the reservoir water and that ammonia is required to be added. Or, if the determination is made that the correct amount of ammonia is being added, the amount of sodium hypochlorite may be reduced and accordingly programmable logic controller sends the required signal to reduce the amount of sodium hypochlorite being added. If the determination is made that the amount of ammonia being added is too low, programmable logic controller 44 sends a signal along line 46 to pump 48 to increase the amount of ammonia to be added. Accordingly, ammonia is added from the ammonia storage tank 150 along line 152 and then along line 154 to water in the reservoir 100. Preferably, the ammonia is added after the water is discharged from jet mixer or mixer 24 to facilitate mixing in the water. As noted earlier with respect to sodium hypochlorite, the programmable logic controller 44 can be programmed to calculate the additional amount of ammonia to be introduced to the reservoir for correction purposes.

If the correct amount of sodium hypochlorite is being added, and the ammonia is high, then programmable logic controller 44 can signal the adjustment to pump 48 to reduce the amount of ammonia being added in order to have the required balance of chlorine and chloramine in the water being treated. It will be appreciated that the impurities in make-up water being added to reservoir 100 can change from time to time depending on the seasons, and the current system automatically adjusts for changes in composition of impurities in make-up or feed water. It should be noted that ammonia and hypochlorite react in the water as follows:
NH₄₊₊OCl⁻→NH₂Cl+H₂O

The chloramine has a longer half life than that of chlorine and thus is preferred for the present invention.

It should be appreciated that programmable logic controller 44 continuously monitors the level of chlorine and chloramine in the water in reservoir 100 using analyzer 26. Then, the programmable logic controller 44 calculates whether or not the correct amount of ammonia and hypochlorite is being added based in the amount present in the sample water. Continuously monitoring the water by analyzer 26 provides the programmable logic controller 44 with information about the water in the reservoir 100 and permits determination by the controller 44 whether the amount of either ammonia or hypochlorite being added is required to be increased or decreased or to remain the same.

In operation, the programmable logic controller 44 makes the comparison, using stored values in memory or logic table or any suitable control algorithm, and decides whether either ammonia or hypochlorite or both need to be increased or decreased, and in response thereto, sends the appropriate signal to the pumps 48 and/or 44 to increase or decrease or maintain the amounts of chemicals being forwarded to the reservoir water. Implementation of the changes can be handled by any controller set up to analyze the data from the analyzer and forward the appropriate signals to pumps 41 and 48. Thus, the controller can be a PID or similar controller or programmable logic controller can be used.

While reference is made herein to sodium hypochlorite, it will be appreciated that any chemical or disinfectant such as potassium or calcium hypochlorite, liquid hypochlorite, gaseous chlorine or ammonia can be used. The preferred hypochlorite is sodium hypochlorite. The sodium hypochlorite can be supplied in bulk and mixed to provide the desired concentration or the sodium hypochlorite can be generated on site as needed by a hypochlorite generator 70 and supplied to tank or supply 40. That is, programmable logic controller 44 can be set to monitor the level of sodium hypochlorite in tank 40. When programmable logic controller 44 detects that level 43 has reached a predetermined level, it sends a signal along line 71 to sodium hypochlorite generator 70 to supply sodium hypochlorite solution to tank 40 along line 56 until level 43 reaches a predetermined level wherein programmable logic controller 44 sends another signal switching off generator 70.

Further, while any method of supplying hypochlorite to tank 40 may be used, a preferred method is disclosed in U.S. Pat. No. 6,805,787, filed Sep. 7, 2001, entitled “Method and System for Generating Hypochlorite” which is incorporated herein by reference as if specifically set forth. In this method for producing sodium hypochlorite, a brine solution is provided for electrolyzing in a first electrolyzer cell and chilled water is added to the brine solution to provide a chilled brine solution which is then added to the electrolyzer cell and subjected for electrolyzing to produce a first hypochlorite and brine solution which has an increase in temperature. To the hypochlorite and brine solution from the first cell is added additional chilled water to lower the temperature of first hypochlorite and brine solution which is added to a second electrolyzing cell and subjected to electrolyzing thereby increasing the amount of sodium hypochlorite to this second solution of sodium hypochlorite and brine solution.

Chilled water is added to the second solution of sodium hypochlorite and brine and the chilled solution is added to a third electrolyzer cell and electrolyzed to further provide sodium hypochlorite in the brine solution. This process is repeated one or more times until the hypochlorite and brine solution passes through all the cells in the electrolyzer assembly. The chilled water added may first be subjected to water softening to remove hardness from the water.

As noted, ammonia is supplied from ammonia storage tank 150 on demand as controlled by programmable logic controller 44. Any source of ammonia can be employed. Typically, in the present invention, a preferred ammonia containment system is designed to hold aqueous ammonia at atmospheric pressure without the necessity of a pressurized system tankage. This is accomplished by providing a double contained insulated polyethylene storage vessel and refrigeration system whereby ammonia is maintained below 60° F., regardless of external ambient temperature. Ammonia is delivered by bulk delivery to external connections, avoiding operator exposure. In the event of refrigeration failure, ammonia solution rate of vapor discharge is limited to energy penetrating the insulated container which greatly reduces any discharges or leaks. As a precautionary measure, redundant refrigeration can be provided.

Referring to FIG. 1 and FIG. 3, one preferred method of this invention submerges a reservoir management system into a large water reservoir to circulate the water, monitor and add chemicals to the water and reduce temperature gradients. In this method a submersible pump assembly is located within the reservoir. The submersible assembly is “free floating” meaning that, because of its frame 50, 80, it is not attached to any portion of the reservoir and therefore, independent of the reservoir. In this preferred method, the submersible pump assembly 20 comprises one or more submersible pumps 22, securely mounted to a frame 50, 80 in a position for optimum stabilization. In one embodiment, the frame 50 has a base 52, a support mounting plate 60 and one or more struts 54 connecting the base 52 to the support mounting plate 60. In this embodiment, one or more ballast tanks 70 are positioned on an outer area of the frame so that they are supported by the frame 50. The reservoir management system is then attached onto the support mounting plate within an inner central area of the frame. Alternatively as illustrated in FIG. 4, the submersible pump assembly 20 is supported by a tripod frame 80. Ballast tanks 70 can be attached to the assembly 20 if desired.

In operation, the submersible reservoir management system is located in the reservoir and a jet of water is discharged from the submersible pump. Water is ingest at a point remote from the discharging. One or more jet mixers 24 are positioned in communication with the submersible pump 22 and operates within the jet of water 18 exiting from the nozzle 32 of the pump 22 from the to pull in low pressure water adjacent the jet mixer 24. A stream of water 16 flows from the jet mixer for increasing flow within the body of water. Disinfectant chemicals are dispersed into one of the jet 18 or the stream 16 for mixing in the body of water. The submersible pump assembly 20 is then repositioned both vertically and horizontally within the reservoir as desired. Vertical positioning is effected by increasing or decreasing the ballast within the one or more ballast tanks. The system is repositioned horizontally manually or by motorized vehicles. Repositioning provides circulation of the water contained within the reservoir so as to diminish temperature gradients within the water and to efficiently mix chemicals added thereto for treatment purposes.

Simultaneously with the recirculation of water within the reservoir, a test stream of water is removed from the reservoir on a continuous basis to ensure that the disinfecting chemicals being circulating are at the required levels in various areas within the reservoir. The level of the chemicals in the test stream is determined to provide a chemical measurement related signal. The signal is then relayed to a controller and within the controller, the signal is compared to a set point indicative of the level of chemical desired in the water in the reservoir to provide a comparison. In response to the comparison, the amount of chemical being added to the reservoir is maintained at its present rate, increased to an effective level or decreased.

Having described the presently preferred embodiments, it is to be understood that the invention may be otherwise embodied within the scope of the appended claims.

1. A submersible reservoir management system for large water reservoirs comprising:
a reservoir management system comprising a means for analyzing reservoir water for chemical content and a means for adding chemicals;
a submersible pump assembly in fluid communication with the reservoir management system; and
a frame removably attached to the pump assembly for supporting and stabilizing the pump assembly when submerged.

2. The submersible reservoir management system of claim 1 wherein the pump assembly comprises one or more submersible pumps and one or more jet mixer for mixing and circulating water.

3. The submersible reservoir management system of claim 1 wherein the frame comprises a base, one or more support struts and a mounting plate.

4. The submersible reservoir management system of claim 3 wherein the base is rectangular and the frame comprises four struts, each strut having a base end and a mounting plate end, each base end connected to a corner of the base and each mounting plate end securely attached to the mounting plate.

5. The submersible reservoir management system of claim 4 wherein the mounting plate further comprises one or more flanges and the four struts are attached to the one or more flanges of the mounting plate.

6. The submersible reservoir management system of claim 1 further comprising one or more ballast tanks to stabilize the system.

7. The submersible reservoir management system of claim 6 further comprising one or more trusses for securing the one or more ballast tanks to the frame.

8. The submersible reservoir management system of claim 6 further comprising a tripod for supporting the submersible pump reservoir management system.

9. A submersible reservoir management system for large water reservoirs comprising:
a reservoir management system comprising a means for analyzing reservoir water for chemical content and a means for adding chemicals;
a submersible pump assembly in fluid communication with the reservoir management system; and
a frame removably attached to the pump assembly for supporting and stabilizing the pump assembly when submerged; and one or more submersible ballast tanks mounted onto the frame for submerging the pump assembly within the water.

10. The submersible reservoir management system of claim 9 wherein the one or more ballast tanks comprise one or more air hoses, one or more water inlets and one or more water outlets.

11. A submersible reservoir management system for large water reservoirs comprising:
a large water reservoir management system comprising one or more submersible pumps, a means for analyzing reservoir water for chemical content, and a means for adding chemicals;
a frame removably attached to the submersible pump for stabilizing the reservoir management system when submerged, the frame comprising a base and one or more struts and a mounting plate for supporting the submersible pump, the base connected to the frame for stabilizing the pump and supporting the pump when the base is positioned on the bottom of the reservoir;
each of the one or more struts having a base end and a mounting plate end, each base end connected to the base and each mounting plate end securely attached to the support mounting plate; and two or more submersible ballast tanks mounted onto the frame so that the pump is positioned on the mounting plate between the ballast tanks.

12. The submersible reservoir management system of claim 11 further comprising one or more jet mixers for mixing and circulating water, wherein the submersible pump comprises a means to produce a jet of water therefrom within the water reservoir and a means to ingest water from the reservoir at a point remote from the jet, wherein the submersible pump is a recirculating pump and the jet mixer is positioned in the jet of water to draw low pressure water surrounding the jet mixer and to discharge a stream of water therefrom to mix and circulate the water within the reservoir and to remove temperature gradients in the body of water.

13. The submersible reservoir management system of claim 11 further comprising a means for adding at least one of ammonia, hypochlorite, and chlorine to the body of water, the means designed to add one of the ammonia, hypochlorite, and chlorine to the stream of water discharging from the pump or the jet mixer, means for removing a test stream of water from the reservoir on a continuous basis, the means designed to remove the test stream remote from the water discharging from jet mixer.

14. The submersible reservoir management system of claim 11 wherein reservoir management system further comprises an analyzer for determining the level of at least one of chlorine and chloramine in the test stream to provide a chlorine or chloramine related signal; and a controller designed to receive the signal and to compare the signal to a set point indicative of the level of chlorine or chloramine desired in the reservoir water to provide a comparison, and in response to the comparison, the controller designed to maintain, increase, or decrease the amount of ammonia, hypochlorite, or chlorine added to the body of water in the reservoir.

15. The submersible reservoir management system of claim 11 wherein each base end of the struts is connected to the base and each mounting plate end is connected to the support mounting plate so that the struts angle inwardly when attached to the base and the support mounting plate.

16. The submersible reservoir management system of claim 11 wherein the one or more ballast tanks comprise one or more air hoses, one or more water inlet and one or more water outlets.

17. A submersible reservoir management system for large water reservoirs comprising:
a water reservoir management system, the reservoir management system comprising a submersible pump assembly, a means for analyzing reservoir water for chemical content and a means for adding chemicals;
the pump assembly comprising one or more submersible pump, one or more jet mixers for mixing and circulating water;
a frame removably attached to the submersible pump for stabilizing the submersible pump when submerged, the frame comprising a tripod; and
two or more submersible ballast tanks.

18. The submersible reservoir management system of claim 17 wherein the tripod frame comprises bracing means.

19. A method for submerging a reservoir management system for large water reservoirs to circulate the water, monitor and add chemicals to the water and reduce temperature gradients, the method comprising:
(a) locating a submersible pump assembly in the reservoir, the submersible pump assembly comprising one or more pumps, one or more jet mixers and a frame, the pump assembly securely mounted to the frame in a position for optimum stabilization;
(b) operating the reservoir management system by analyzing the reservoir water for chemical content and, if necessary adding chemicals;
(c) positioning the submersible pump vertically within the reservoir and continuing to operate the reservoir management system to provide mixing action within various areas within the reservoir so as to diminish temperature gradients within water contained in the reservoir and to efficiently mix chemicals added thereto for treatment purposes; and
(d) repositioning the reservoir management system horizontally and or vertically within the reservoir.

20. The method of claim 19 further comprising one or more ballast tanks for vertically positioning the reservoir management system within the reservoir.

21. The method of claim 19 wherein the frame comprises a base, a support mounting plate and one or more struts connecting the base to the support mounting plate, the base sized so that the base is larger than the support mounting plate causing the struts angle inwardly when connecting the base to the support mounting plate.

22. The method of claim 19 wherein the frame comprises a tripod.

23. A method for submerging a reservoir management system for large water reservoirs to circulate the water, monitor and add chemicals to the water and reduce temperature gradients, the method comprising:
(a) locating a submersible pump assembly in the reservoir, the submersible pump securely mounted to a frame in a position for optimum stabilization, and positioning one or more ballast tanks on the submersible pump assembly (b) discharging a jet of water from the pump and ingesting water at a point remote from the discharging;
(c) operating a jet mixer in the jet of water to pull in low pressure water adjacent the jet mixer;
(d) flowing a stream of water from the jet mixer for increasing flow within the body of water;
(e) dispersing disinfectant chemicals in one of the jet or the stream for mixing in the body of water; and
(f) repositioning the submersible pump vertically within the reservoir by increasing or decreasing the ballast within the one or more ballast tanks to provide circulation of the water contained within the reservoir so as to diminish temperature gradients within the water and to mix chemicals added thereto for treatment purposes.

24. The method of claim 23 further comprising:
(g) simultaneously with the mixing, removing a test stream of water from the reservoir on a continuous basis;
(h) determining the level of the chemicals in the test stream to provide a chemical measurement related signal;
(i) relaying the signal to a controller;
(i) in the controller, comparing the signal to a set point indicative of the level of chemical desired in the water in the reservoir to provide a comparison; and
(k) in response to the comparison, maintaining, increasing or decreasing the amount of chemical being added to the reservoir.

25. The method of claim 23 wherein the frame comprises a base, a support mounting plate and one or more struts connecting the base to the support mounting plate, the base sized so that the base is larger than the support mounting plate causing the struts angle inwardly when connecting the base to the support mounting plate, the method further comprises positioning the reservoir management system within an inner central area of the frame.

26. The method of claim 23 wherein the frame comprises a tripod.

27. The method of claim 23 further comprising repositioning the submersible pump horizontally within the reservoir.
